(19) United States
(12) Patent Application Publication
(10) Pub. No.: US 2015/0369772 A1
(43) Pub. Date: Dec. 24, 2015

(54) PROCESSING OF NUCLEOTIDE SEQUENCES

(71) Applicant: KONINKLIJKE PHILIPS N.V., Eindhoven (NL)

(72) Inventors: ANJA VAN DE STOLPE, EINDHOVEN (NL); HARMA MARTINE FEITSMA, EINDHOVEN (NL); PIETER JAN VAN DER ZAAG, EINDHOVEN (NL); REINHOLD WIMBERGER-FRIEDL, EINDHOVEN (NL); JACOB MARINUS JAN DEN TOONDER, EINDHOVEN (NL); ANKE PIERIK, EINDHOVEN (NL); FREEK VAN HEMERT, EINDHOVEN (NL)

(21) Appl. No.: 14/764,601

(22) PCT Filed: Jan. 23, 2014
(86) PCT No.: PCT/IB2014/058480

§ 371 Date: Jul. 30, 2015

Related U.S. Application Data
(60) Provisional application No. 61/761,827, filed on Feb. 7, 2013.

(51) Int. Cl. G01N 27/327

(52) U.S. Cl. CPC G01N 27/3275

(57) ABSTRACT

The invention relates to a method and an apparatus (100) for the processing of nucleotide sequences. An apparatus (100) according to an embodiment of the invention comprises an array of electrodes (120a,120b, . . . ), wherein at least one nanoball (NB) comprising replications of a nucleotide sequence (1,2) of interest is attached to an electrode to which only one nanoball (NB) of that size can be attached at the same time. Thus a unique association of electrodes (120a,120b, . . . ) to nucleotide sequences (1,2) of interest can be achieved. The nanoballs (NB) are preferably produced by rolling circle amplification. Application of attractive and/or repulsive electric potentials to the electrodes (120a,120b, . . . ) can be used to control the attachment of nanoballs (NB). The measurement of changes in the capacitance of electrodes (120a,120b, . . . ) can be used to detect and monitor the incorporation of mono- or oligonucleotides provided sequentially by different solutions (A, T, G, C) into strands that are replicated in a nanoball (NB) at an electrode.

### FIELD OF THE INVENTION

The invention relates to an apparatus and a method for the processing of sequences of nucleotides, particularly for the determination of DNA/RNA nucleotide order.

### BACKGROUND OF THE INVENTION

The WO 2012/042399 A1 discloses a biosensor device comprising a plurality of electrodes that are coated with different DNA-primers. The electrical capacitance of the electrodes is monitored which allows to attribute changes of capacitance to the addition of nucleotides to a replicated DNA-primer. By exposing the electrodes sequentially to different solutions of mononucleotides, it can be controlled which nucleotide is currently added. In order to be able to assign an observed addition at an electrode to one particular type of primer, it is important that each electrode is coated with only one kind of primer. In the procedure described in WO 2012/042399 A1, only about 37% of the available electrodes can be coated in this manner with a single type of primer, while the residual electrodes comprise no primer at all or two or more different primers in parallel, which allow no unique interpretation of measurement signals.

### SUMMARY OF THE INVENTION

It would be advantageous to provide means that allow for a more efficient processing of nucleotide sequences with an electrode array.

This concern is addressed by an apparatus according to claim 1, a method according to claim 2, and a use according to claim 15. Preferred embodiments are disclosed in the dependent claims.

According to a first aspect, an embodiment of the invention relates to an apparatus for the processing of nucleotide sequences, said apparatus comprising the following components:
An array of electrodes.
At least one nanoball comprising replications of a nucleotide sequence of interest, wherein said nanoball is attached to an electrode to which not more than one nanoball of that size can be attached at a time.

The processing that is done by the apparatus may be any kind of manipulation of nucleotide sequences one is interested in, for example the splitting of sequences or the replication of a strand of nucleotides. In a preferred embodiment, the processing comprises the stepwise replication of a primer having an unknown sequence of nucleotides for the purpose of determining said sequence. In this case, the apparatus is configured as a biosensor.

The processed nucleotide sequences may for instance comprise (but are not limited to): raw samples (bacteria, virus, genomic DNA, etc.); purified samples, such as purified genomic DNA or RNA; the product(s) of an amplification reaction; biological molecular compounds such as nucleic acids and related compounds (e.g. DNAs, RNAs, oligonucleotides or analogs thereof, PCR products, genomic DNA, bacterial artificial chromosomes and the like).

The term “array” shall denote an arbitrary one-, two- or three-dimensional arrangement of a plurality of elements (here electrodes). Typically the electrode array is two-dimensional and preferably also planar, and the electrodes are arranged in a regular pattern, for example a grid or matrix pattern.

The electrodes of the array may in general all be individually designed. Preferably, all electrodes or at least sub-groups of all electrodes are however identical or similar in shape, size and/or material. The electrodes shall be electrically conductive and it shall be possible to set them to a given electrical potential. Most preferably, sub-groups of electrodes or even single electrodes may be individually addressable, i.e. they can individually be supplied with a desired electrical potential.

The term “nanoball” generally denotes a large molecule or a complex having a compact, for example (approximately) spherical shape with an inner diameter ranging typically between about 1 nm and about 1000 nm, preferably between about 50 nm and about 500 nm. Here and in the following, the term “inner diameter” of an object shall be defined as the diameter of the largest geometric sphere that can completely be inscribed into said object.

The nanoball in question here shall comprise replications of a nucleotide sequence of interest. These replications are typically arranged one behind the other in a continuous linear strand of nucleotides, though other configurations are possible, too (e.g. branched molecules and/or molecules with spacer elements of different composition between the replications of the sequence of interest). This tandem repeat structure together with the single-stranded nature of the DNA induce a nanoball folding configuration.

The attachment of the nanoball to the associated electrode may be achieved by any appropriate effect. The nanoball may for example be covalently bound to the surface of the electrode and/or be attached to some primer that is provided on said surface and/or be bound noncovalently via hydrophobic or electrostatic interactions.

The electrode surface could be chemically modified to allow for attachment of the nanoballs. Such a modification, if with charged molecules or polymers, can optionally be supported and/or be improved by applying appropriate charges to the electrodes, such that the modification is quickly brought in contact with the surface independent of diffusion, and applied in a homogeneous, thin layer.

An apparatus of the kind described above has the advantage that a large number of replications of a nucleotide sequence of interest can readily be associated to one electrode because it is added with the attachment of just a single nanoball. At the same time, it is guaranteed that no other nanoball that might comprise replications of another nucleotide sequence can attach to the same electrode. This automatically insures that the respective electrode is dedicated to one particular nucleotide sequence of interest only. Due to this automatic uniqueness of the association between sequences and electrodes, it is possible to provide substantially every electrode of the array with a nanoball, thus exploiting the complete array for processing purposes.

Though an apparatus in which only one single nanoball is attached to one electrode is comprised by the present invention, there will typically be a plurality of nanoballs, each of them being attached to a different one of the electrodes. As explained above, it is most preferred that a nanoball is attached to each electrode of the array. Moreover, it is preferred that at least one first nanoball (attached to a first electrode) of a plurality of nanoballs comprises replications of a first nucleotide sequence of interest and that at least one second nanoball (attached to a second electrode) comprises replications of a second, different nucleotide sequence of interest. Thus the associated electrodes are dedicated to the processing of different nucleotide sequences of interest. If all attached nanoballs are composed of replications of different sequences of interest, the array of electrodes is optimally exploited as each electrode is dedicated to another sequence.

According to a second aspect, the invention relates to an embodiment of a method for the processing of nucleotide sequences, wherein at least one nanoball comprising replications of a particular nucleotide sequence of interest is attached to an electrode of an array of electrodes to which only one nanoball of that size can be attached.

The method and the apparatus are different realizations of the same inventive concept, i.e. the matching between electrodes and nanoballs of replicated nucleotide sequences. Explanations and definitions provided for one of these realizations are therefore valid for the other realization, too.

In the following, various preferred embodiments will be described that relate to both the apparatus and the method defined above.

In one preferred embodiment, the inner diameter of the nanoball is larger than about 40% of the inner diameter of the associated electrode. It is hence not necessary that the nanoball covers the complete area of the electrode in order to block the attachment of other nanoballs.

In principle, there is no upper limit on the size of the nanoball relative to the electrode(s). Hence the nanoball could also be bigger than the electrode. It could particularly be covering multiple (e.g. four) electrodes, each of which would then give the same signal.

In general, the electrodes of the apparatus might be arranged on an outer surface that can be exposed to the environment or be immersed into some medium. According to a preferred embodiment, the apparatus comprises a container with a reaction chamber that can be filled with a medium of interest and in which the electrodes are located (typically on the bottom surface of the chamber).

The aforementioned container may preferably comprise an inlet to which at least two different reagent reservoirs can selectively be coupled. Thus the medium adjacent to the electrodes can controllably be changed. For example, if the incorporation of nucleotides into a replicated strand by a polymerase shall be observed (“sequencing by synthesis”), the reagent reservoirs may comprise solutions of pure mononucleotides. If the incorporation of oligonucleotides into a replicated strand by a ligase shall be observed (“sequencing by ligation”), the reagent reservoirs may comprise solutions of pure oligonucleotides. When a reagent supply with adenosine nucleotides is for example coupled to the inlet, the container will provide a medium with these nucleotides adjacent to the electrodes, allowing for the observation of the incorporation of adenosine nucleotides at the electrodes. More details about this approach may be found in the WO 2012/042399 A1, which is incorporated into the present text by reference.

Preferably, the aforementioned reagent reservoirs may comprise media with different dielectric characteristics (e.g. buffers, buffer components) that can be sensed by the electrodes. Thus the medium the electrodes are currently exposed to can be inferred.

The electrodes of the apparatus may particularly be coupled to a processing circuit that allows for a measurement of the capacitance of the electrodes. As the capacitance of an electrode changes if new nucleotides are incorporated into a nanoball attached to the electrode, this incorporation step can be monitored by capacitive measurements. Capacitance of the electrodes (with respect to the surrounding medium) can for instance be measured via their response (amplitude, phase) to a (preferably high frequency) load. Another procedure may comprise the repetitive application of different voltages to the electrodes, wherein the total amount of charge that is transported this way is determined. Further details of a possible procedure for measuring the capacitance of the electrodes may be found in the WO 2012/042399 A1.

In a preferred embodiment of the method, the electrodes of the array are exposed to a plurality of nanoballs comprising replications of nucleotide sequences of interest, said nanoballs having sizes such that only one of them can be attached to an electrode at a time. Each of the nanoballs typically comprises replications of only one single nucleotide sequence of interest to be uniquely associated to that sequence. Moreover, different nanoballs of the plurality of nanoballs may preferably comprise replications of different nucleotide sequences of interest (i.e. a first nanoball comprises a first sequence of interest, a second nanoball a second, different sequence of interest etc.). Exposing the array of electrodes to such a cocktail of nanoballs insures automatically that each electrode will in the end be associated to (at most) one particular nucleotide sequence of interest, allowing for a unique interpretation of the measurement results.

In another embodiment of the method, the electrodes of the array are exposed to a plurality of nanoballs comprising replications of nucleotide sequences of interest, wherein said electrodes can be addressed individually or as ensembles to specifically attract said nanoballs from a supernatant solution. Thus the attachment of nanoballs to electrodes can be done in a controlled way.

The nanoball(s) that is/are attached to the electrode(s) of the array may preferably be produced by rolling circle amplification (RCA). RCA is a known procedure in which a nucleotide sequence that is formed as a ring serves as a template from which a continuous strand of replications of the sequence is produced. Details of this procedure may be found in literature (e.g. Lizardi et al., “Mutation detection and single-molecule counting using isothermal rolling-circle amplification”, Nature Genetics 19, 225-232 (1998); Asiello et al., “Miniaturized isothermal nucleic acid amplification, a review”, Lab Chip, 2011, 11, 1420-1430 (2011); Zhao et al., “Rolling Circle Amplification: Applications in Nanotechnology and Biodetection with Functional Nucleic Acids”, Angewandte Chemie International Edition ISSN: 1433-7851, Vol: 47 (34) 2008, page: 6330-6337 (2008)). The production of one kind of nanoball (or a plurality of different nanoballs) by RCA may optionally take place in the volume adjacent to the electrodes or in a separate vessel.

In another preferred embodiment, electrical potentials may selectively be applied to electrodes of the array in order to attract and/or repel nanoballs and/or other components of the adjacent medium. When an array of uncoated electrodes is for example for a first time exposed to a medium comprising nanoballs, appropriate electrical potentials may be applied to the electrodes to ensure that nanoballs will only attach to a desired sub-group of the electrodes. The other electrodes can for example be left free for purposes of reference or for the later attachment of other nanoballs (e.g. with reference nucleotide sequences) that may be provided with another a medium. Theoretically, it is thus possible to provide each single electrode selectively with a nanoball from a specific medium.

In a typical application of the described apparatus and method, the electrical capacitance of electrodes with attached nanoball is measured and preferably monitored over time. Changes in capacitance will then provide information about processes taking place at the electrodes and/or in the attached nanoballs, particularly information about the incorporation of nucleotides and/or oligonucleotides into strands that are currently replicated at said nanoball. Moreover, changes of capacitance may indicate the binding of a nanoball to an electrode.

As already indicated above, the array of electrodes may sequentially be exposed to different solutions of mononucleotides and/or oligonucleotides. Reactions that are observed at the electrodes can hence uniquely be attributed to the mononucleotide or oligonucleotide that is at the respective moment in the solution adjacent to the electrode.

The invention further relates to the use of the apparatus described above for sequencing nucleic acids, molecular diagnostics, biological sample analysis, chemical sample analysis, food analysis, and/or forensic analysis.

### BRIEF DESCRIPTION OF THE DRAWINGS

These and other aspects of the invention will be apparent from and elucidated with reference to the embodiments described hereinafter.

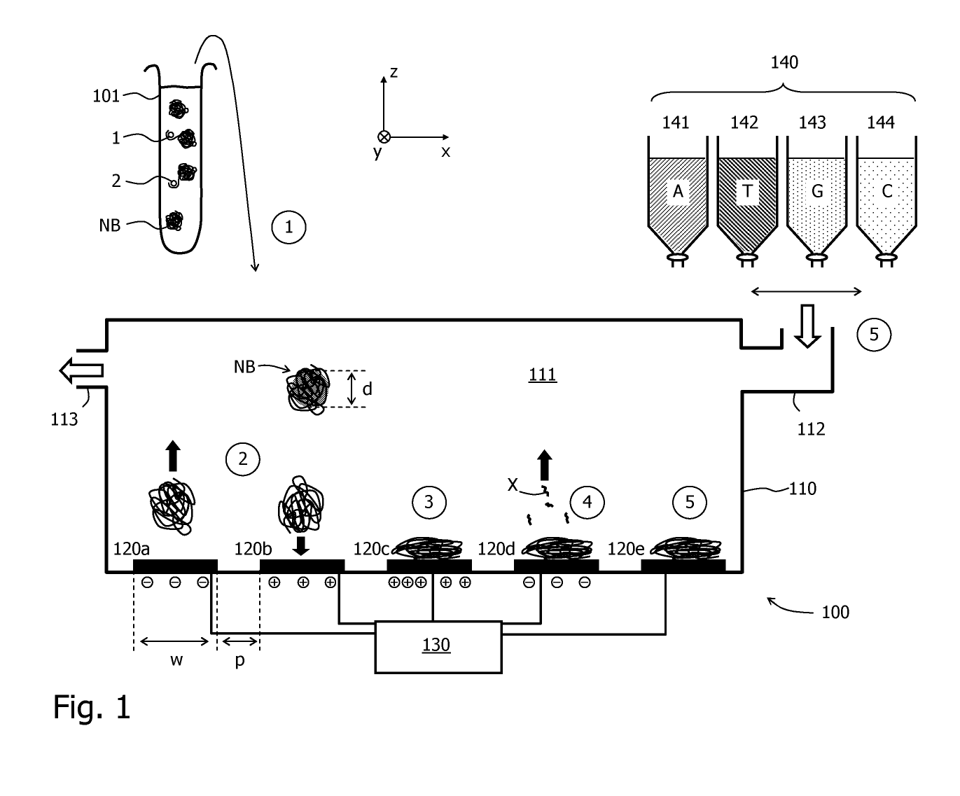

The only drawing, FIG. 1, schematically illustrates an embodiment of a biosensor apparatus according to the invention.

### DETAILED DESCRIPTION OF EMBODIMENTS

Nucleic acid sequencing technology is rapidly improving, and will therefore be the future method of choice for molecular diagnostics in genetics, pathology and oncology. However, none of the currently available technologies meets the requirements for routine diagnostic use in terms of cost, fidelity and ease-of-use. Many sequencing-by-synthesis technologies use fluorescently labeled, reversible terminated nucleotides, which are expensive and chemically unfamiliar to normal DNA polymerases. Technologies that measure the incorporation reaction of a new nucleotide rather than the nucleotide itself have the advantage that a normal polymerase and normal, unlabeled nucleotides can be used, which strongly reduces cost and improves fidelity. One example of this is “454 sequencing” (Roche), in which the pyrophosphate molecule that is released at incorporation of a nucleotide is detected by an enzymatic reaction that produces visible light, but this enzymatic reaction requires additional steps and is expensive. Another example is a technology in which the electrical capacitance of electrodes is monitored which allows to attribute changes of capacitance to the addition of nucleotides to a replicated DNA-primer on the electrodes (WO 2012/042399 A1). A disadvantage of this method is that most of the electrodes cannot be used if a unique association between primer and electrode shall be guaranteed.

To address the mentioned issues, it is proposed here to use a capacitive (bio-)sensor for sequencing, by placing amplified clones of molecules to be read on a flat (nano-)electrode surface and detecting the capacitive change of new nucleotides built onto these clones. In this method the capacitive change of the extra nucleotide addition is a permanent change, such that the signal measurement can be integrated over a longer period and therefore likely gives a robust signal. Moreover, nanoballs of replicated nucleotide sequences of interest are used that have a size which allows for the attachment of only one nanoball per electrode.

FIG. 1 schematically illustrates an apparatus or biosensor 100 that is designed according to an embodiment of the above general principle and a method that can be executed with such a biosensor.

In the shown embodiment, the biosensor 100 comprises a container 110 with a reaction chamber 111 that can be filled with a medium (fluid) to be processed. For this purpose, the container 110 is provided with an inlet 112 via which a medium can be supplied and with an outlet 113 via which medium can be removed from the reaction chamber.

Moreover, a reagent supply 140 with several individual reagent reservoirs 141, 142, 143, 144 is provided, wherein each of these reservoirs can selectively be coupled to the inlet 112 for introducing the associated reagent into the reaction chamber 111. This is achieved by microfluidic connections to supply different reagents one by one and wash buffers in between.

The biosensor 100 further comprises a plurality of electrodes 120a, 120b, 120e that are located in a two-dimensional array (only the extension in x-direction is visible) on the bottom of the reaction chamber 111. The surface of the electrodes should preferably be planar and allow for modification or coating to create a substrate to which DNA molecules can be attached. The number of electrodes is typically larger than about 100, preferably larger than about 1000. The electrodes are individually coupled to a processing circuit 130 which can apply different electrical potentials individually to the electrodes. Moreover, the processing circuit 130 shall be able to measure the capacitance of the electrodes (with respect to the surrounding medium) individually. This may for instance be achieved with a method as described in the WO 2012/042399 A1.

The biosensor 100 can be prepared and used for the sequencing of nucleotide sequences of interest in the following manner:

In a first step (\textcircled{1}), nanoballs NB comprising replications of nucleotide sequences of interest are produced. This production may take place in a separate container or tube 101 (as shown) or in the reaction chamber 111. The nanoballs may particularly be generated by rolling circle amplification (“RCA”) starting from ring-shaped templates of the nucleotide sequences 1, 2 of interest (typically a number of different templates in the order of the number of electrodes in the array will be present). RCA is a clonal amplification method that creates tandem duplicates of the sequence of interest, resulting in large single-stranded DNA molecules consisting of typically 100-10000 copies of the sequence of interest in one molecule. As a result of this process, nanoballs NB with inner diameters d are generated each of which comprises replications of a particular nucleotide sequence of interest. In this context, the “inner diameter” of a nanoball is defined as the diameter of the largest sphere (indicated in grey shade in the FIGURE for one nanoball) that can completely be inscribed into the nanoball. The inner diameter d of the shown nanoballs NB typically ranges between about 100 nm and 500 nm.

In a second step of the preparation procedure, the array of electrodes in the reaction chamber 111 is exposed to the generated cocktail of nanoballs NB. This is illustrated at \textcircled{2} at electrodes 120a and 120b of the electrode array. The electrodes can during this stage selectively be put to different positive or negative (or neutral) electrical potentials which attract the nanoballs (here assumed for positive potentials) or repel the nanoballs (here assumed for negative potentials). Thus the attachment of nanoballs to selected subgroups of electrodes can be controlled. Moreover, a change of capacitance of the electrodes may optionally be monitored during this step to detect the attachment of a nanoball, enabling keeping track of “filled” electrodes during the sequencing reaction.

As the nanoballs will usually all carry some charge of the same sign (typically negative), they will repel each other (dependent on buffer), which further aids in spacing the nanoballs over the electrodes.

The typical size of the nanoballs NB, expressed e.g. by their inner diameter d, is chosen in relation to the size of the electrodes 120a-120f, wherein the latter size may for example be measured by the inner diameter w of the electrodes (illustrated for circular electrodes in the FIGURE). This relation is such that the size of the nanoball(s) makes it essentially impossible that more than one nanoball can be attached to a single electrode at the same time (“essentially” meaning with a probability of more than 95%, preferably more than 99%, as multiple bindings can hardly be excluded with certainty). Typical values for the inner diameter w of the electrodes range between about 100 nm and about 200 nm. The pitch p between electrodes is typically in the range of about 400 nm to about 800 nm. In general, the pitch p should be larger than the diameter d of the nanoballs.

The mentioned size relation can be realized by adapting the size of the nanoballs to a given size of electrodes (e.g. by stopping RCA at an appropriate point in time), by manufacturing electrodes with a size that fits to a predetermined size of nanoballs, or by a combination of both approaches (tuning both electrode and nanoball sizes). Regarding the first option, the following estimation can be made: A 100-fold to 10000-fold amplification of templates of about 10 to 1000 nt (nucleotides) results in nanoballs of about 50000 to about 500000 nucleotides. Using a polymerase with a known speed, e.g. about 1-100 nt/sec, gives the option to tune the nanoball-size to a preferred value.

In an optional third step of the procedure, illustrated at \textcircled{3} at electrode 120c, an attractive potential at the electrodes may be used to further bind and flatten attached nanoballs at a selected electrode surface, thus improving the capacitive signal produced by these electrodes. To this end, the attractive potential at the electrode may optionally be increased in comparison to the previous step.

In an optional fourth step of the procedure, illustrated at \textcircled{4} at electrode 120d, a repulsive electrical potential may be applied to the electrodes in order to remove unbound disturbing components X (“garbage”, e.g. nucleotides or primers) from the electrodes. Thus the noise from reactions that are not related to the incorporation of nucleotides into a nanoball of interest can be reduced.

After this, preparation of the biosensor 100 is accomplished and the actual measurements can begin, i.e. the sequencing of the nucleotide sequences 1, 2 of interest that are comprised in multiple copies by the different nanoballs NB on the electrodes. This is illustrated at \textcircled{5} at the electrode 120e.

During the sequencing procedure, the reaction chamber 111 is sequentially filled with the reagent media from the reagent reservoirs 141-144. Each of these reservoirs comprises a different reagent, for example a different one of the mononucleotides A, T, G, and C (alternatively solutions of oligonucleotides could be used). When a solution with a particular mononucleotide, say adenosine A, fills the reaction chamber 111, any change of capacitance that is observed at a particular electrode can uniquely be attributed to the incorporation of that mononucleotide A into the strand which is replicated in the associated nanoball NB on the electrode.

Before a new reagent solution is introduced into the reaction chamber 111, a repulsive potential can be applied to the electrodes (as shown above in the fourth step) to repel loose nucleotides that have not been incorporated during the sequencing reaction.

Addition of one single nucleotide to a single molecule does hardly give a detectable capacity change at an electrode. For robustness, in order to obtain a detectable signal per nucleotide built in, one needs clones of identical molecules, to all of which the same nucleotide is added. These clones are provided in the described approach by the nanoballs produced e.g. with rolling circle amplification. RCA gives large freedom of biochemical design, for example to perform the amplification reaction in solution in a separate tube. Subsequently, these nanoballs of DNA can be deposited on the biosensor surface and be kept attached by specific or nonspecific interactions with the surface. Alternatively, the first primer can directly be attached to the surface and the amplification can be performed then.

The circular DNA that serves as template for rolling circle amplification can be created in different ways. In one example the ends of random fragments of DNA are ligated together to form a circle. The use of rolling circle amplification (RCA) additionally allows for applications with targeted sequencing. The RCA can be based on specific primers (selector technology) such that only certain sequences are amplified. Or the genome-wide RCA clones can be hybridized to sequence-specific probes on magnetic beads for isolation or directly on the biosensor surface, such that only certain clones are sequenced. Also, multiple fragments can be ligated together to form one circle. In another example circular virus genomes can directly be used as template. RCA molecules could be specifically modified during or post-amplification to create binding sites for binding to the sensor surface.

As all clonal copies produced with RCA are in one molecule, the clones can be manipulated. With regard to the biosensor, one can attract or repel the nanoballs by putting a positive or negative voltage on the electrodes. Since the nanoballs can be tuned to have similar size as the electrodes (typically 100-300 nm), a very efficient surface filling can be obtained, filling virtually all electrodes, but none of them with more than one nanoball because of their size. This is a large improvement compared to previously described methods, where on average only about ⅓ of electrodes are in use. With the described method a 25-fold potential density than possible for optical sequencing can be obtained, which is relevant for the number of sequences that can be read in parallel in a single run. Additionally, the nanoballs can be attracted into a flatter conformation on the surface, fitting into the active height in which capacity measurement is possible. Calculations show that electrical translocation of nanoballs at sufficient speed is possible with voltages that do not cause electrolysis at the open electrode surface (up to 1 V). In particular, for a nanoball with a typical size (200 nm) and charge (10⁵ nt, corresponding to 10⁵ electron charges), when applying 1 V and −1V to the electrodes, a translocation speed of about 0.2 m/s is achieved, which is sufficient for chamber heights of order 50 μm.

By applying voltage to specific electrodes or rows of electrodes, one can direct nanoballs to specific places. As such, one can e.g. create a spatial ranking on the sensor, which makes it possible to retain a priori information and use it in the sequencing analysis. For example, one can have certain positions of control sequences, measure different samples in parallel, or keep certain electrodes empty to provide a control signal. Using repulsive voltages can help in repelling loose nucleotides that have not been incorporated in the sequencing reaction, and thereby improve washing.

In the described procedures, reagent fluids are flown sequentially over the sensor surface, e.g. in a plug flow manner (i.e. when individual reagents are supplied sequentially in a continuous flow, kept separate by their chemical properties or by the design and size of the microfluidic system). By giving the different fluids distinguishable characteristics (e.g. dielectric properties), one can follow in the read out all steps of the sequencing process and exactly define the one nucleotide addition signal profile.

In summary, an embodiment of the invention has been described that relates to a method and an apparatus for the processing of nucleotide sequences. The apparatus comprises an array of electrodes, wherein at least one nanoball comprising replications of a nucleotide sequence of interest is attached to an electrode to which only one nanoball of that size can be attached at the same time. Thus a unique association of electrodes to nucleotide sequences of interest can be achieved. The nanoballs are preferably produced by rolling circle amplification. Application of attractive and/or repulsive electric potentials to the electrodes can be used to control the attachment of nanoballs. The measurement of changes in the capacitance of electrodes can be used to detect and monitor the incorporation of mononucleotides provided sequentially by different solutions into strands that are replicated in a nanoball at an electrode. The invention can for example be applied for the detection of nucleic acid mutations for diagnostics, e.g. in the fields of healthcare, oncology, and pathology.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An apparatus for the processing of nucleotide sequences, comprising:
an array of electrodes; and
at least one nanoball comprising replications of a nucleotide sequence of interest, wherein said nanoball is attached to an electrode to which not more than one nanoball of that size can be attached,
wherein electrical potentials are selectively applied to the electrodes of the array in order to attract and/or repel nanoballs and/or other components.

2. A method for the processing of nucleotide sequences,
wherein at least one nanoball comprising replications of a nucleotide sequence of interest is attached to an electrode of an array of electrodes to which not more than one nanoball of that size can be attached,
wherein electrical potentials are selectively applied to the electrodes of the array in order to attract and/or repel nanoballs and/or other components.

3. The apparatus of claim 1,
wherein the inner diameter of the nanoball is larger than about 40% of the inner diameter of the associated electrode.

4. The apparatus of claim 1,
wherein it comprises a container with a reaction chamber in which the array of electrodes is located, said container having an inlet to which at least two different reagent reservoirs can selectively be coupled.

5. The apparatus of claim 4,
wherein the reagent reservoirs comprise solutions (A, T, G, C) with different dielectric characteristics.

6. The apparatus of claim 1,
wherein it comprises a processing circuit (130) that allows the selective application of electrical potentials to the electrodes.

7. The apparatus of claim 1,
wherein the electrodes of the array are exposed to a plurality of nanoballs comprising replications of nucleotide sequences of interest, said nanoballs having sizes such that substantially only one of them can attach to one electrode at the same time.

8. The apparatus of claim 1,
wherein the electrodes of the array are exposed to a plurality of nanoballs comprising replications of nucleotide sequences of interest, wherein said electrodes can be addressed individually or as ensembles to specifically attract said nanoballs from a supernatant solution.

9. The apparatus of claim 1,
wherein the nanoball is produced by rolling circle amplification.

10. (canceled)

11. The apparatus of claim 1,
wherein the capacitance of electrodes is or can be measured.

12. The apparatus of claim 11,
wherein binding of a nanoball to an electrode is or can be detected via the associated change of capacitance at said electrode.

13. The apparatus of claim 11,
wherein additions of nucleotides and/or oligonucleotides to a nanoball attached to an electrode are or can be detected via the associated change of capacitance at said electrode.

14. The apparatus of claim 1,
wherein the array of electrodes is sequentially exposed to different solutions (A, T, G, C) of mono- or oligonucleotides.

15. Use of the apparatus of claim 1 for sequencing nucleic acids, molecular diagnostics, biological sample analysis, chemical sample analysis, food analysis, and/or forensic analysis.
